(19) United States
(12) Patent Application Publication
(10) Pub. No.: US 2017/0013328 A1
(43) Pub. Date: Jan. 12, 2017

(54) NetGames

(71) Applicant: Darryl Smith, Detroit, MI (US)

(72) Inventor: Darryl Smith, Detroit, MI (US)

(21) Appl. No.: 14/792,631

(22) Filed: Jul. 7, 2015

(51) Int. Cl. H04N 21/81; H04N 21/4788; H04N 21/4405; H04N 7/16; H04N 21/422; H04N 21/475; H04N 21/8358; H04N 21/61; H04N 21/414; H04N 21/4627; H04N 21/478; H04N 21/454

(52) U.S. Cl. CPC H04N 21/8173; H04N 21/4781; H04N 21/4788; H04N 21/4405; H04N 7/165; H04N 21/454; H04N 21/4756; H04N 21/8186; H04N 21/8358; H04N 21/6175; H04N 21/41407; H04N 21/4627; H04N 21/42221

(57) ABSTRACT

A multimedia on demand marketplace system that is comprised of a transaction-processing enabled multimedia server that is configured to connect to an internet-based network for a seller to publish multimedia content and to transmit multimedia content programs on the demand of a buyer to be purchased on a webpage, connected via said internet-based network. The invention includes a means to process and encode said published multimedia content with a copyright overlay watermark and store said published multimedia content to render it searchable a plurality of customer premises units that are connected to said internet-based network via a network interface and configured to receive said multimedia content programs via said internet-based network. The invention includes a remote control unit that is in communication with each customer premises unit to provide user input to the unit and a multimedia content system that is connected to each customer premises unit.

### CROSS REFERENCE TO RELATED APPLICATION

Not applicable.

### FEDERALLY SPONSORED RESEARCH AND DEVELOPMENT

Not applicable.

### MICROFICHE APPENDIX

Not applicable

### BACKGROUND OF THE INVENTION

(1) Field of the Invention

The present invention relates to the field of multimedia delivery on customer demand over an internet based network.

(2) Background

The next generation of media, places all content in systems, which makes things more effective and efficient. Content in this generation is downloaded to the system which cuts back on damaging equipment. For example scratches and lost/stolen games are the top concerns regarding damaging equipment. Children also get exposed to games at a relatively young age, which is another factor in the increase of having a defect. For example when they are younger, children don't know the damage they can do to a game by holding it by the bottom of the disc. Also using different things to wipe games off, can also add damage to the equipment. For example, using other material such as shirts and paper towels can cause more damage.

Broadcasts of programming via direct satellite, cable television (CATV) networks, and other conventional video delivery networks typically deliver predetermined audio video programs at predetermined times. However, the consumer has always desired the freedom of watching the programs of his or her own choosing at the times of his or her own choosing.

As an alternative, consumers will often elect to use a video rental store or delivery service to obtain and view programs of their choice at a convenient time. The former requires the consumer to go to a video rental store to rent a DVD or VHS cassette. The latter requires the delivery service to mail the DVD to the customer, and this process usually takes 2-4 days to get the desired video in hand. During this time, the viewer might loose interest in the particular video. After receiving and viewing the video, the consumer must mail back the DVD to the video retailer or others, which presents an inconvenience to the user.

Other methods of delivering video programming on demand to a consumer include Pay-Per-View (PPV). In a PPV system, the cable operator or satellite service company provides a stream of various scrambled programs at predetermined times. If the customer desires to watch a particular program, the cable operator or satellite service company send an authorization key to customer's set top box to descramble the broadcasted program on customer's request. In this manner the user can watch the program of his/her choice by paying for the particular program. However in PPV systems, a user's choice is limited to the titles and programs made available for Pay-Per-View by the cable operator or satellite service company, which typically includes only a relatively small number of selections.

Customer demand for full video on demand service to customer premises, such as to the delivery of any demanded video to customer premises at any time, with full recording functionalities, has been increasing. In the past few years, various video on demand services have been proposed to address this need, but each has very limited features. Such services not only require a huge infrastructure, but also require very high bandwidth connectivity to end user premises.

### SUMMARY OF THE INVENTION

The present invention is a marketplace system that provides a multimedia content be bought and sold online on a user's demand.

The system comprises of a server that is multimedia server enabled to process transaction. The server is connected to an internet-based network, where a seller can publish multimedia content like games online and the server also transmits multimedia content programs on the demand of a buyer that is to be purchased or viewed on a webpage, connected via the internet-based network.

Further the system provides a means to process and encode said published multimedia content with a copyright overlay watermark and store the published multimedia content to render it searchable to a plurality of customer premises units like PC, smartphones, XBOX and PLAYSTATION as exemplary video game consoles, Laptops etc. connected to said internet-based network via a network interface and configured to receive said multimedia content programs via the internet-based network. Furthermore the system of the invention has a remote control unit in communication with each customer premises unit to provide user input to the unit and a multimedia content system connected to each customer premises unit. Also the invention provides a means to store the multimedia content, the information and meta-tags about the multimedia content on the system, moreover the system allows the multimedia contents to be searched and remove if said seller deletes the multimedia content.

The invention provides means for a seller to submit multimedia contents through a number of channels such as personal digital assistants, cell phones, personal digital assistants, gaming consoles, computers; any channel with a web browser, connected to the Internet through wired or wireless connection and has access to the multimedia content file, and for the seller to remain a copyright ownership of the multimedia content file until it is purchased by the buyer. According to the invention sellers can establish a price for multimedia contents that they publish, also sellers can determine whether they want to list multimedia content for exclusive or non-exclusive rights usage, a buyer according to the system of the invention browse the published multimedia content, subscribe to the multimedia content, stream the content and access the multimedia content for a fixed period of time, wherein the period of time and the cost for the subscribing, streaming and accessing is defined by a seller, further the buyers can unsubscribe a subscribed multimedia content and subscribe a different multimedia content. Furthermore, the system stores information related to the seller, buyer, transaction and finances.

In one embodiment of the invention the server in the system enables cross system interaction between the plurality of customer premises units that are connected to the internet-based network. The customer premises units of the system may communicate between each other using BLUETOOTH, a short-range wireless interconnection technology typically used with cellular phones, computers, or other electronic devices, further the system provides a means that enables a buyers or a sellers to post blogs indicating various descriptive attributes reviews related to a published multimedia content.

In a preferred embodiment the multimedia server of the system is configured to ensure only authentic usage of the services by transmitting the online multimedia content programs in scrambled and encrypted format such that the programs can only be descrambled, decompressed and decrypted at authentic customer premises equipment. The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### DETAILED DESCRIPTIONS OF THE INVENTION

The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication such as (but not limited to)—multi-purpose pocket computers, personal multimedia devices, etc.

The various devices on which the applications that implement the present invention run may use one or more processors with different instruction-sets, architectures, clock-speeds, etc. and memory that may include high speed random access memory and may include non-volatile memory such as one or more magnetic disk storage devices, flash memory devices and other kinds of solid state memory devices.

The various applications that can implement the present invention run on electronic devices that may use at least one physical user interface device that provide the means of control and navigation within the operating system and applications that run on the devices include (but not limited to) touch-pads such as those described in (but not limited to)—(1) U.S. patent application Ser. No. 10/722,948 (“Touch pad for handheld device”, filed Nov. 25, 2003); (2) U.S. patent application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheel such as those described in U.S. patent application Ser. No. 11/549,619 “Method, device, and graphical user interface for dialing with a click wheel” filed on Oct. 13, 2006, keyboards such as those mentioned in (but not limited to) U.S. patent application Ser. No. 07/711,760 (“Ergonomic keyboard input device”, filed on Jun. 6, 1991), mouse such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means such as those described in (but not limited to) (1) European Patent application publication number: EP2482176 A2 (“Multi-input gesture control for a display screen”, filed on Nov. 4, 2011) and (2) U.S. Patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (light Emitting Diode) technology, CRT (Cathode ray tube) technology, or LPD (light emitting polymer) technology or any other display technologies. Various realizations of graphics display circuitry that implement a Graphics Processing Unit (GPU) are used to achieve video interface between user and these electronic devices.

Connectivity of these devices with networks such as the internet, an intranet and/or wireless network such as cellular telephone network, a wired or wireless local area network (LAN) and/or metropolitan area network (MAN) and/or WAN (wide area network) and other wireless communication is achieved by use of a plurality of communication standards, protocols and technologies like BLUETOOTH, Wireless Fidelity (Wi-Fi) and/or any other suitable communication protocol, including communication protocols not yet developed as of the filing date of this document.

The present invention maybe implemented on applications that run on a single or variety of operating system platforms including but not limited to OS X, WINDOWS, UNIX, IOS, ANDROID, SYMBIAN, LINUX, or embedded operating systems such as VxWorks.

The present invention may also be implemented to work with various web browsers including but not limited to Internet Explorer, Mozilla Firefox, Safari and Opera that access and handle various types of web pages constructed with various mark-up languages such as HTML, HTML-5, XHTML, XML, etc. and the associated CSS (cascading style sheet) files and java-script files.

Provided herein is a system which is an online marketplace wherein multimedia content is searched bought and sold, a user as per the system can demand multimedia content for subscription, also the user will have the option to surf different types of multimedia contents like games, where they could find out they have interest in different games.

The system comprises of a server that is multimedia server enabled to process transaction. The server is connected to an internet-based network, where a seller can publish multimedia content like games online and the server also transmits multimedia content programs on the demand of a buyer that is to be purchased or viewed on a webpage, connected via the internet-based network.

Further the system provides a means to process and encode said published multimedia content with a copyright overlay watermark and store the published multimedia content to render it searchable to a plurality of customer premises units like PC, smartphones, XBOX, PLAYSTATION, Laptops etc. connected to said internet-based network via a network interface and configured to receive said multimedia content programs via the internet-based network. Furthermore the system of the invention has a remote control unit in communication with each customer premises unit to provide user input to the unit and a multimedia content system connected to each customer premises unit. Also the invention provides a means to store the multimedia content, the information and meta-tags about the multimedia content on the system, moreover the system allows the multimedia contents to be searched and remove if said seller deletes the multimedia content.

The invention provides means for a seller to submit multimedia contents through a number of channels such as personal digital assistants, cell phones, personal digital assistants, gaming consoles, computers; any channel with a web browser, connected to the Internet through wired or wireless connection and has access to the multimedia content file, and for the seller to remain a copyright ownership of the multimedia content file until it is purchased by the buyer. According to the invention sellers can establish a price for multimedia contents that they publish, also sellers can determine whether they want to list multimedia content for exclusive or non-exclusive rights usage, a buyer according to the system of the invention browse the published multimedia content, subscribe to the multimedia content, stream the content and access the multimedia content for a fixed period of time, wherein the period of time and the cost for the subscribing, streaming and accessing is defined by a seller, further the buyers can unsubscribe a subscribed multimedia content and subscribe a different multimedia content. For example the seller would charge the buyer for a game and the buyer can keep the game for the month. A buyer, at the beginning of the subscription cycle can keep the game(s) they have experience in or a new one to try. Buyers could purchase a 1 game monthly access for example, $8 a month. But for an additional $8 they can pick 2 games. But if they have no interest in the game they are allowed to exchange the subscribed game and pick another game for $4, if the buyer further wants to exchange he/she could do that for $2, rather than waiting until the next cycle to repeat the same steps. At the end of each cycle (month or when the next payment is due), they have the option to keep the game(s) they have or put them back and pick other games. This allows the buyer to have more options and experience different games they probably would have never experienced or thought about playing.

Furthermore, the system stores information related to the seller, buyer, transaction and finances.

In one embodiment of the invention the server in the system enables cross system interaction between the plurality of customer premises units that are connected to the internet-based network. The Cross-system function allows users (buyers) to have the comfort of the controller which they used to playing with, along with their settings. For example, NBA2K, with a user playing on XBOX, he/she might like his/her camera view in a particular way. But to a PLAYSTATION user might like his/her camera angle a different manner, the cross system would allow such setting.

The customer premises units of the system may communicate between each other using BLUETOOTH technology, further the system provides a means that enables a buyers or a sellers to post blogs indicating various descriptive attributes reviews related to a published multimedia content. When a user browses for a particular game, they can see reviews on a scale of 1-5 how the game is rated overall, a brief description of what the game is about, and a short demo previewing some of the content involved with playing the game, making a user aware of the content to see if it draws his/her interest.

In a preferred embodiment the multimedia server of the system is configured to ensure only authentic usage of the services by transmitting the online multimedia content programs in scrambled and encrypted format such that the programs can only be descrambled, decompressed and decrypted at authentic customer premises equipment.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

1. A multimedia on demand marketplace system, comprising:
a transaction processing enabled multimedia server configured to connect to an internet-based network for a seller to publish multimedia content and to transmit multimedia content programs on demand of a buyer to be purchased on a webpage, connected via said internet-based network;
a multimedia server with a means to process and encode said published multimedia content with a copyright overlay watermark and store said published multimedia content to render it searchable by a plurality of customer premises units connected to said internet-based network via a network interface and configured to receive said multimedia content programs via said internet-based network;
a remote control unit in communication with each customer premises unit to provide user input to the unit.
an multimedia content system connected to each customer premises unit.

2. A multimedia on demand marketplace system as claimed in claim 1, wherein said invention provides means for said seller to submit multimedia contents through a number of channels such as personal digital assistants, cell phones, personal digital assistants, gaming consoles, computers; any channel with a web browser, connected to the Internet through wired or wireless connection and has access to the multimedia content file, and for said seller to remain a copyright ownership of the multimedia content file until it is purchased.

3. A multimedia on demand marketplace system as claimed in claim 1, wherein said invention provides means for said sellers to establish a price for multimedia contents.

4. A multimedia on demand marketplace system as claimed in claim 1, wherein said invention provides means for said seller to determine whether they want to list said multimedia content for exclusive or non-exclusive rights usage.

5. A multimedia on demand marketplace system as claimed in claim 1, configured to store said multimedia content and information and meta-tags about said multimedia content on the system, allow said multimedia contents to be searched, and remove said multimedia content if said seller deletes said multimedia content.

6. A multimedia on demand marketplace system as claimed in claim 1, wherein said invention provides means to store said seller information, buyer information, transaction information and financial information.

7. A multimedia on demand marketplace system as claimed in claim 1, wherein said invention provides means for said buyers to browse said multimedia content, subscribe said multimedia content, streaming said multimedia content and access said multimedia content for a fixed period of time and cost.

8. A multimedia on demand marketplace system as claimed in claim 7, wherein the fixed period of time to subscribe said multimedia content, streaming said multimedia content and access said multimedia content is defined by said seller.

9. A multimedia on demand marketplace system as claimed in claim 7, wherein the cost to subscribe said multimedia content, streaming said multimedia content and access said multimedia content is defined by said seller.

10. A multimedia on demand marketplace system as claimed in claim 7, wherein said invention provides mean for said buyers to unsubscribe a said subscribed multimedia content and subscribe a different multimedia content.

11. A multimedia on demand marketplace system as claimed in claim 1, wherein server enables cross system interaction between said plurality of customer premises unit connected to said internet-based network.

12. A multimedia on demand marketplace system as claimed in claim 1, wherein said invention provides means for said buyers and said sellers to post blogs indicating various descriptive attributes, reviews related to a published multimedia content.

13. A multimedia on demand marketplace system as claimed in claim 1, wherein said customer premises units can communicate using BLUETOOTH.

14. A multimedia on demand marketplace system as claimed in claim 1, wherein the multimedia server is configured to ensure only authentic usage of the services by transmitting said online multimedia programs in scrambled and encrypted format such that the programs can only be descrambled, decompressed and decrypted at authentic customer premises equipment.
